(19) United States
(12) Patent Application Publication
(10) Pub. No.: US 2013/0184975 A1
(43) Pub. Date: Jul. 18, 2013

(54) METHOD OF CONTROLLING ENGINE SHUT DOWN

(71) Applicants: Shouhao Wu, Roselle, IL (US); Robert L. Rowells, Elmwood Park, IL (US)

(72) Inventors: Shouhao Wu, Roselle, IL (US); Robert L. Rowells, Elmwood Park, IL (US)

(73) Assignee: International Engine Intellectual Property Company LLC, Lisle, IL (US)

(21) Appl. No.: 13/642,832

(22) PCT Filed: Apr. 22, 2010
(86) PCT No.: PCT/US10/32020

§ 371 Date: Apr. 2, 2013

(51) Int. Cl. F02D 41/04

(52) U.S. Cl. CPC F02D 41/042
USPC 701/112

(57) ABSTRACT

A method of shutting down an engine determines whether an ignition key is in a first shutdown position. An exhaust gas recirculation valve closes when the ignition key is in the first shutdown position. The engine runs for a predetermined period of time after the exhaust gas recirculation valve is closed. The engine shuts down after running the engine for the predetermined period of time.

### TECHNICAL FIELD

The present disclosure relates to an engine having a two-stage shut down switch and a method for controlling the shut down of an engine, and more particularly to a method of shutting down an engine that delays the shut down of the engine under certain conditions.

### BACKGROUND

Many modern diesel engines include exhaust gas recirculation “EGR” systems that route exhaust gas into the air intake system of the engine in order to reduce engine emissions. As emission standards have become more stringent, the amount of EGR placed into the air intake system has increased, and steps have been taken in many engines to lower the temperature of the intake manifold of the air intake system, as both of these parameters have been found to reduce engine emissions, such as NOx emissions and particulate matter emissions. Low intake manifold temperatures may cause condensation to form and accumulate within the intake manifold. Materials in the EGR may form a solution with the accumulated condensation in the intake manifold, particularly when the engine is turned off The solution formed by the EGR and the condensation accumulated in the intake manifold is often acidic, and may cause corrosion that damages components of the engine, including the intake manifold, and intake valves of the engine. This damage may be increased when the engine is shut off, as the solution may sit in contact with engine components for a longer period of time, leading to enhanced levels of corrosion. Therefore, a need exists for a method to shut down an engine that reduces the accumulation of condensation and EGR solution within the air intake system of the engine.

### SUMMARY

According to one process, a method of shutting down an engine is provided. The method determines whether an ignition key is in a first shutdown position. An exhaust gas recirculation valve closes when the ignition key is in the first shutdown position. The engine runs for a predetermined period of time after the exhaust gas recirculation valve is closed. The engine shuts down after running the engine for the predetermined period of time.

According to another process, a method of shutting down an engine is provided. The method determines whether an ignition key is in a first shutdown position. An exhaust gas recirculation valve closes when the ignition key is in the first shutdown position. The engine speed increases to a predetermined speed higher than idle. The engine runs for a predetermined period of time after the exhaust gas recirculation valve is closed and the engine speed is increased. The engine shuts down after running the engine for the predetermined period of time.

According to a further process, a method of shutting down an engine is provided. The method determines whether an ignition key is in a first shutdown position. An exhaust gas recirculation valve closes when the ignition key is in the first shutdown position. A cold start assist system on the engine is activated. The engine runs for a predetermined period of time after the exhaust gas recirculation valve is closed and the cold start assist system is activated. The engine shuts down after running the engine for the predetermined period of time.

### BRIEF DESCRIPTION OF THE DRAWINGS

FIG. 1 is a block diagram showing a process of shutting down an engine according to one process.

FIG. 2 is a block diagram showing a process of shutting down an engine according to another process.

FIG. 3 is a block diagram showing a process of shutting down an engine according to a further process.

### DETAILED DESCRIPTION

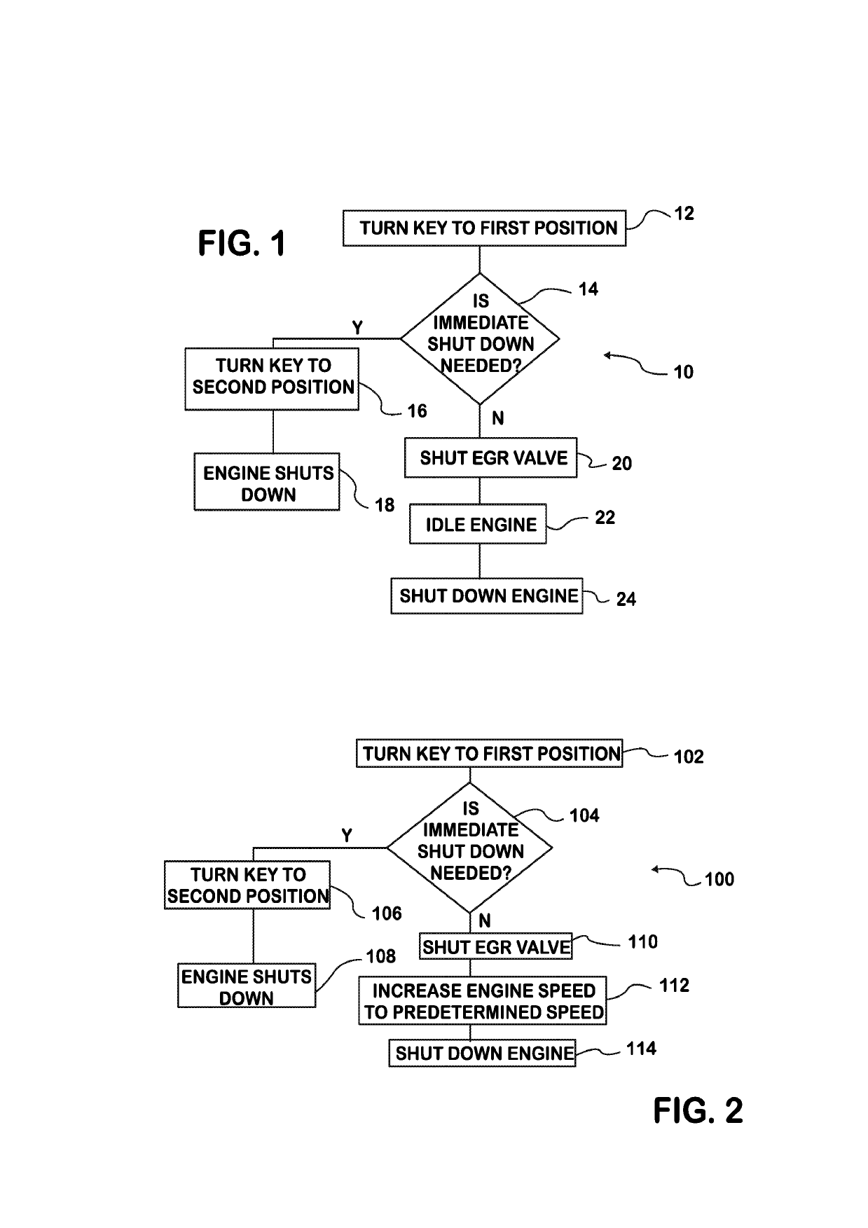

FIG. 1 shows a block diagram for a method of shutting down an engine 10. A user initiates the method 10 by turning an ignition key to a first shut down position 12. Once the ignition key is in the first shut down position, the user determines if an immediate shut down of the engine is required as shown at block 14. If an immediate shut down is required, the user turns the ignition key to a second shutdown position as shown in block 16. The engine shuts down soon after the ignition key is placed in the second shut down position as shown in block 18.

If no immediate shut down is required, an exhaust gas recirculation (“EGR”) valve is closed at block 20, preventing additional EGR from entering an air intake system of the engine. The prevention of EGR entering the air intake system reduces the likelihood of EGR mixing with condensation to form a corrosive solution within the air intake system. Once the EGR valve has been closed, the engine idles for a pre-programmed period of time as shown at block 22. The pre-programmed period of time may be stored in a memory disposed in electrical communication with an electronic control module (“ECM”) of the engine. The pre-programmed period of time may range from about ten seconds to about thirty seconds, depending on a variety of factors, such as ambient temperature, ambient humidity, engine operating temperature, and intake manifold temperature. Once the engine has idled for the pre-programmed period of time, the engine shuts down, as shown at block 24. It is contemplated that the user may remove the key from the ignition when the engine is placed in the first shut down position, such that the user does not have to wait for the engine to fully shut down before leaving a vehicle containing the engine. The engine may not be operated by a user, such as to accelerate a vehicle, without a key, therefore a measure of safety is provided, as well as a theft resistance feature.

FIG. 2 depicts a block diagram showing another method of shutting down an engine 100. The user initiates the method 100 by turning the ignition key to a first shut down position 102. When the ignition key is in the first shut down position, the user determines if an immediate shut down of the engine is required as shown at block 104. If an immediate shut down is required, the user turns the ignition key to a second shutdown position as shown in block 106. The engine shuts down soon after the ignition key is placed in the second shut down position as shown in block 108.

If no immediate shut down is required, an exhaust gas recirculation (“EGR”) valve is closed at block 110, preventing additional EGR from entering an air intake system of the engine. The prevention of EGR entering the air intake system reduces the likelihood of EGR mixing with condensation to form a corrosive solution within the air intake system. Once the EGR valve has been closed, the engine speed is set to a predetermined engine speed that is stored in a memory in communication with the ECM. The predetermined engine speed is typically a higher speed than the engine's idle speed. The predetermined engine speed is sufficient to increase air flow in the air intake system to help reduce condensation within the air intake system. The engine operates at the predetermined engine speed for a pre-programmed period of time that may range from about ten seconds to about thirty seconds, depending on a variety of factors, such as ambient temperature, ambient humidity, engine operating temperature, and intake manifold temperature. Once the engine has operated at the predetermined engine speed for the pre-programmed period of time, the engine shuts down, as shown at block 114.

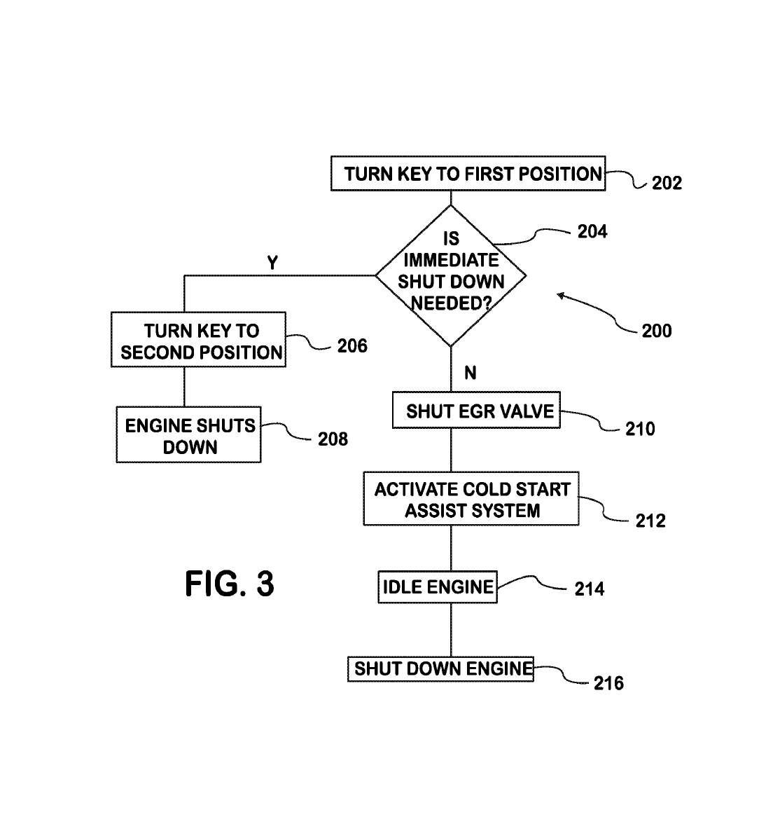

FIG. 3 depicts a block diagram showing another method of shutting down an engine 200. The user initiates the method 200 by turning the ignition key to a first shut down position 202. When the ignition key is in the first shut down position, the user determines if an immediate shut down of the engine is required as shown at block 204. If an immediate shut down is required, the user turns the ignition key to a second shutdown position as shown in block 206. The engine shuts down soon after the ignition key is placed in the second shut down position as shown in block 208.

If no immediate shut down is required, an exhaust gas recirculation (“EGR”) valve is closed at block 210, preventing additional EGR from entering an air intake system of the engine. The prevention of EGR entering the air intake system reduces the likelihood of EGR mixing with condensation to form a corrosive solution within the air intake system. Once the EGR valve has been closed, a cold start assist system is activated at block 212. The cold start assist system produces heat that raises the temperature of air within the air intake system. The heat produced by the cold start assist system reduces the amount of condensation within the air intake system. In addition to activating the cold start assist system, the method also includes allowing the engine to idle for a pre-programmed period of time, as shown at block 214, to assist in removing condensation from the air intake system. The pre-programmed period of time may be stored in a memory disposed in electrical communication with the ECM of the engine. The pre-programmed period of time may range from about ten seconds to about thirty seconds, depending on a variety of factors, such as ambient temperature, ambient humidity, engine operating temperature, and intake manifold temperature. Once the engine has idled for the pre-programmed period of time, the engine shuts down, as shown at block 216.

What is claimed is:

1. A method of shutting down an engine comprising:
determining whether an ignition key is in a first shutdown position;
closing an exhaust gas recirculation valve when the ignition key is in a first shutdown position;
running the engine for a predetermined period of time after the exhaust gas recirculation valve is closed; and
shutting down the engine after running the engine for the predetermined period of time.

2. The method of claim 1 further comprising:
determining whether the ignition key is in a second shutdown position; and
shutting down the engine generally simultaneously to determining that the ignition key is in the second shutdown position.

3. The method of claim 1, wherein the predetermined period of time is from about 10 seconds to about 30 seconds.

4. The method of claim 1, wherein the running the engine for a predetermined time is at an engine idle speed.

5. The method of claim 1, wherein the predetermined period of time is based upon atmospheric conditions.

6. The method of claim 1, wherein the predetermined period of time is based upon an intake manifold temperature of the engine.

7. The method of claim 1, wherein the predetermined period of time is stored in a look table of a memory disposed in electronic communication with an electronic control module of the engine.

8. A method of shutting down an engine comprising:
determining whether an ignition key is in a first shutdown position;
closing an exhaust gas recirculation valve when the ignition key is in a first shutdown position;
increasing engine speed to a predetermined speed higher than idle;
running the engine for a predetermined period of time after the exhaust gas recirculation valve is closed and the engine speed is increased; and
shutting down the engine after running the engine for the predetermined period of time.

9. The method of claim 8 further comprising:
determining whether the ignition key is in a second shutdown position; and
shutting down the engine generally simultaneously to determining that the ignition key is in the second shutdown position.

10. The method of claim 8, wherein the predetermined period of time is from about 10 seconds to about 30 seconds.

11. The method of claim 8, wherein the predetermined period of time is based upon atmospheric conditions.

12. The method of claim 8, wherein the predetermined period of time is based upon an intake manifold temperature of the engine.

13. The method of claim 8, wherein the predetermined speed higher than idle is stored in a look table of a memory disposed in electronic communication with an electronic control module of the engine.

14. The method of claim 8, wherein the predetermined speed higher than idle is based upon an intake manifold temperature of the engine.

15. The method of claim 8, wherein the predetermined speed higher than idle is based upon atmospheric conditions.

16. A method of shutting down an engine comprising:
determining whether an ignition key is in a first shutdown position;
closing an exhaust gas recirculation valve when the ignition key is in a first shutdown position;
activating a cold start assist system on the engine;
running the engine for a predetermined period of time after the exhaust gas recirculation valve is closed and the cold start assist system is activated; and
shutting down the engine after running the engine for the predetermined period of time.

17. The method of claim 16 further comprising:
determining whether the ignition key is in a second shutdown position; and
shutting down the engine generally simultaneously to determining that the ignition key is in the second shutdown position.

18. The method of claim 16, wherein the predetermined period of time is from about 10 seconds to about 30 seconds.

19. The method of claim 16, wherein the predetermined period of time is based upon atmospheric conditions.

20. The method of claim 16, wherein the predetermined period of time is based upon an intake manifold temperature of the engine.
